(19) United States
(12) Patent Application Publication
(10) Pub. No.: US 2014/0083166 A1
(43) Pub. Date: Mar. 27, 2014

(54) Thermoelectric moisture detector

(71) Applicant: Fabian Henrici, Stuttgart (DE)

(72) Inventor: Fabian Henrici, Stuttgart (DE)

(21) Appl. No.: 14/007,881

(22) PCT Filed: Feb. 2, 2012
(86) PCT No.: PCT/EP12/51721

§ 371 Date: Dec. 6, 2013

(30) Foreign Application Priority Data
Apr. 1, 2011 (DE) 10 2011 006 638.1

(51) Int. Cl. G01N 25/56

(52) U.S. Cl. CPC G01N 25/56
USPC 73/25.04; 136/242

(57) ABSTRACT

The apparatus has a chemical energy reservoir that releases thermal energy upon contact with moisture. The apparatus furthermore has a converter that is embodied to convert the thermal energy into electrical energy; and a circuit that is embodied to generate, operated by the electrical energy, an electrical signal for reporting the event.

### FIELD OF THE INVENTION

The present invention relates to an apparatus for reporting an event, to a method for reporting an event, to a monitoring system, and to a use of a chemical energy reservoir, which can be used in particular in conjunction with microsystems.

### BACKGROUND INFORMATION

A variety of autonomous microsystems have already been developed. The problem arises in this context, however, of an adequate energy supply, for which purpose either a battery or a combination of an energy harvester and a buffer battery are used. When a battery alone is used, the service life of the microsystem is limited. When an energy harvester is used, it is in principle impossible to guarantee functionality of the microsystem at a specific point in time, since it is not known in advance whether the energy harvester has recovered sufficient energy from the environment. This affects all forms of energy harvesting from the environment.

### SUMMARY OF THE INVENTION

In light of this, the present invention presents an apparatus for reporting an event, a method for reporting an event, a monitoring system, and a use of a chemical energy reservoir, according to the main claims. Advantageous embodiments are evident from the respective dependent claims and from the description that follows.

The present invention is based on the recognition that an apparatus for reporting an event can be operated reliably when sufficient energy for operating the circuit can be recovered as a result of the occurrence of the event. Since the quantity of energy to be recovered from the event itself is often limited, an energy reservoir is provided which, in response to the event, releases energy that is used to operate the circuit. The energy reservoir thus acts as a kind of amplifier, with which the energy resulting from the event itself can be amplified. The apparatus thus does not have to rely on obtaining, from the environment, sufficient energy to operate the apparatus. It is also not necessary to equip the apparatus with a battery. Utilization in safety-critical system is thus especially appropriate.

The guaranteed provision of energy thus allows the use of autonomous microsystems in safety-critical systems. Likewise, in contrast to a battery, an extremely long service life for the microsystem can be guaranteed. Costs can also be reduced, since neither a sensor element for directly sensing the event, nor a battery for supplying energy to the microsystem, are required.

The present invention creates an apparatus for reporting an event, having the following features:
a chemical energy reservoir that is embodied to release thermal energy upon being influenced by the event;
a converter that is embodied to convert the thermal energy into electrical energy; and
a circuit that is embodied to generate, operated by the electrical energy, an electrical signal for reporting the event.

The event can be a change in a state in the environment in which the apparatus is disposed. The event can be, for example, the occurrence of water or moisture, a temperature change, or a motion. The event initiates a reaction in the chemical energy reservoir which results in the release of thermal energy in the form of waste heat. The energy reservoir can be made of a suitable substance for that purpose. The energy reservoir can thus be constituted by a quantity of the suitable substance. The substance can be a salt or a metal oxide, for example calcium oxide. The converter can be thermally coupled to the energy reservoir so that the thermal energy can be transferred with as little loss as possible to the converter. For that purpose, the converter can be disposed directly adjacent to the energy reservoir. The converter can be a thermoelectric generator. The converter can be embodied to generate an electrical voltage suitable for operation of the circuit, as well as an electrical current sufficient for operation. The converter can be connected to the circuit via electrical contacts or electrical leads. The electrical circuit can be disposed directly adjacent to the converter.

The circuit, the converter, and the energy reservoir can thereby form one compact element. The circuit can be an integrated circuit. The circuit can be based on silicon technology or on organic circuitry. The circuit can be embodied to generate the electrical signal with a predetermined signal shape. The circuit can have a transfer interface, and can be embodied to make the electrical signal available to the transfer interface. The electrical signal can be transferred to an evaluation device via the transfer interface. The circuit can be operated exclusively by way of the energy made available by the converter. Because sufficient energy for operating the apparatus is available only when the event occurs, the apparatus functions as a sensor for the event. When the event occurs, the apparatus is active and makes the electrical signal available. If the event does not occur, however, the apparatus is then inactive and does not make the electrical signal available. The electrical signal thus indicates an occurrence of the event.

According to an embodiment, the energy reservoir, the converter, and the circuit form a microsystem. A “microsystem” can be understood as a system whose dimensions are on the scale of micrometers. A microsystem is notable on the one hand for a small space requirement and on the other hand for a low energy requirement.

The apparatus can have a housing for receiving the energy reservoir, the converter, and the circuit. The housing can have, in the region of the energy reservoir, an environmental interface to enable the energy reservoir to be influenced by the event. The housing can completely enclose the energy reservoir, the converter, and the circuit. The housing can also constitute a pan, open on one side, in which the energy reservoir, the converter, and the circuit are disposed. The environmental interface can be a region having high thermal conductivity in order to convey heat from the environment of the housing to the energy reservoir. The environmental interface can also be suitable for directing moisture from an environment of the apparatus through a wall of the housing to the energy reservoir.

The environmental interface can encompass, for example, an opening of the housing. The environmental interface can encompass a single opening that is located in the region of the energy reservoir or extends over a region of the energy reservoir. The environmental interface can also be constituted by a plurality of openings. By way of an opening, water in particular can be guided very effectively from an environment of the apparatus to the energy reservoir.

The event can thus be an occurrence of moisture. The energy reservoir can be embodied to release thermal energy upon contact with moisture. The energy reservoir can thus be made of a material that reacts exothermically upon contact with water.

According to an embodiment, the converter can encompass a thermocouple. By way of a thermocouple, thermal energy can be converted into an electrical voltage, a temperature difference existing in the region of the thermocouple being utilized in that context. The voltage generated by the thermocouple can be used to operate the circuit. In order to generate sufficient electrical energy, the converter can have a plurality of thermocouples connected in series. Thermocouples can be implemented to be very small, and are thus suitable for use in microsystems.

The electrical circuit can furthermore have a radio interface for wireless transfer of the electrical signal. The radio interface can be an antenna. The electrical signal can thereby be transferred to a remotely located evaluation device with no need for a connecting lead between the apparatus and the evaluation device.

The present invention furthermore creates a monitoring system having the following features:
at least one apparatus in accordance with an embodiment of the present invention; and
an evaluation device that is embodied to receive the electrical signal of the at least one apparatus via an interface, and evaluate it.

The evaluation device can be an electrical circuit. The evaluation device can be continuously in operation, and can have for that purpose a suitable energy supply, for example a battery or a connection to a power grid. If the electrical signal is emitted from the apparatus via a radio interface, the evaluation device can then have an antenna for reception of the signal. The evaluation device can be embodied to trigger an alarm when the electrical signal is received.

The present invention furthermore creates a method for reporting an event, which encompasses the following steps:
having in readiness a chemical energy reservoir in an influence region of the event, the chemical energy reservoir being embodied to release thermal energy in response to the event;
converting the thermal energy into electrical energy;
using the electrical energy to generate an electrical signal in order to report the event.

The method can be implemented by an apparatus for reporting an event, in accordance with an embodiment of the present invention. The method is suitable for reporting an event whenever sufficient energy cannot be recovered, from the environment or from the event itself, to convey by way of an autonomously acting apparatus a report regarding an event that has occurred, and when battery operation of the autonomously acting apparatus is not possible or not desired.

The present invention further creates a use of a chemical energy reservoir, which is embodied to release thermal energy being upon influenced by an event, in order to operate a circuit that is embodied to generate, operated by the thermal energy converted into electrical energy, an electrical signal for reporting the event.

The invention will be explained below in more detail, by way of example, with reference to the attached drawings.

### BRIEF DESCRIPTION OF THE DRAWINGS

FIG. 1 shows an apparatus in accordance with an exemplifying embodiment of the present invention.

FIG. 2 shows a monitoring system in accordance with an exemplifying embodiment of the present invention.

FIG. 3 shows a flow chart of a method in accordance with an exemplifying embodiment of the present invention.

### DETAILED DESCRIPTION

In the description below of exemplary embodiments of the present invention, identical or similar reference characters are used for the elements that are depicted in the various Figures and operate similarly; repeated description of those elements is omitted.

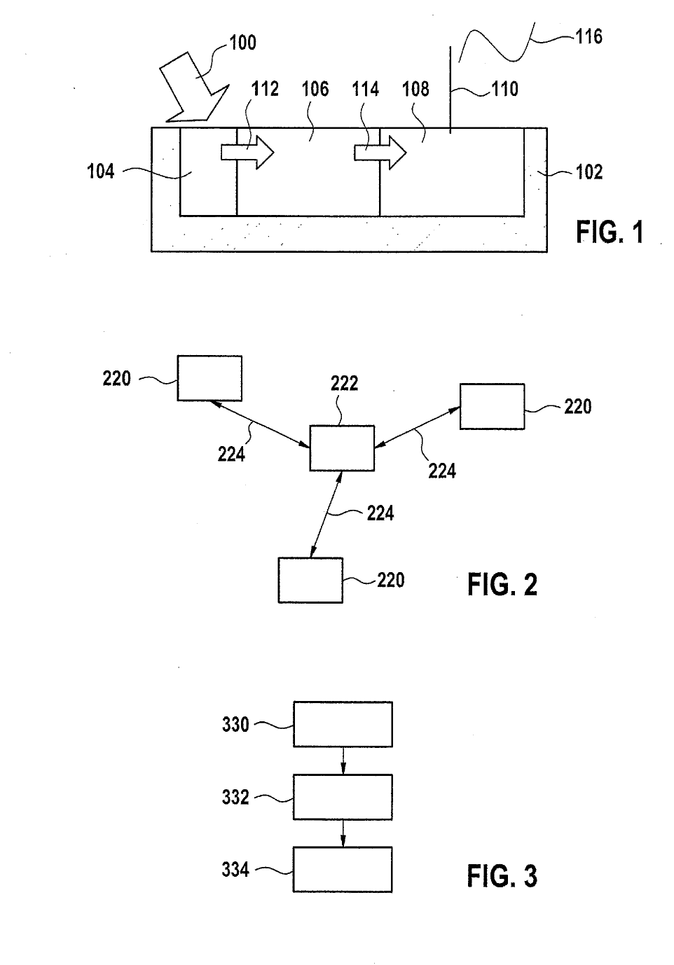

FIG. 1 shows an apparatus for reporting an event 100, in accordance with an exemplifying embodiment of the present invention. The apparatus has a housing 102, a chemical energy reservoir 104, a converter 106, and an electrical circuit 108 having an antenna 110. Housing 102 has a bottom and a peripheral wall. Chemical energy reservoir 104, converter 106, and electrical circuit 108 are disposed inside housing 102. Housing 102 has no cover. Antenna 110 projects out of housing 102. Chemical energy reservoir 104, converter 106, and electrical circuit 108 are disposed next to one another, converter 106 being disposed between chemical energy reservoir 104 and electrical circuit 108.

As indicated by the arrow, event 100 can act directly on a surface, not covered by housing 102, of chemical energy reservoir 104. Chemical energy reservoir 104 is embodied to generate thermal energy as a consequence of the action of event 100, and to transfer said energy via heat transfer 112 to converter 106. Converter 106 is embodied to convert the thermal energy received from chemical energy reservoir 104 into electrical energy, and to transfer it by energy transfer 114 to electrical circuit 108. Electrical circuit 108 is embodied to generate, activated by the electrical energy, an electrical signal and to output said signal to antenna 110. The electrical signal can be emitted via antenna 110, in the form of a radio message 116, into an environment of the apparatus. Radio message 116 is thereby emitted as a consequence of the action of event 100 on the apparatus.

Different energy reservoirs 104 can be provided in order to allow events 100 of different types to be detected and reported. Energy reservoirs 104 can have different substances. Each substance can be embodied to generate heat as a result of the action of the event associated with it. When acted upon by an event associated with a different substance, however, the substance can remain stable and not react. In this case converter 106 can have multiple energy reservoirs 104 associated with it, or a separate converter 106 can be provided for each energy reservoir 104.

In accordance with an exemplifying embodiment, the apparatus is implemented as a microsystem. Event 100 is an occurrence of water. The chemical energy reservoir is a chemical, or encompasses a chemical, that releases heat upon contact with water. Calcium oxide may be recited, for example, as a possible chemical. As a result of the action of water, calcium oxide reacts to calcium hydroxide with evolution of heat. Heat is transferred to converter 106 as a result of heat transfer 112. Converter 106 is embodied as an energy harvester, for example in the form of a thermopile. Energy is transferred from converter 106 to electrical circuit 108 by energy transfer 114. Electrical circuit 108 is embodied as an integrated electronic system.

FIG. 1 shows, in the form of a sectioned image, the schematic construction of the autonomous microsystem having chemical energy reservoir 104, in accordance with a exemplifying embodiment of the present invention. The microsystem is made up of a cell 102, open to the environment, which is filled e.g. with calcium oxide as energy reservoir 104. Upon contact with water 100, calcium oxide 104 reacts with vigorous release of heat 112. This heat 112 is converted by energy harvester 106, e.g. a thermopile, into an electrical voltage 114. Integrated circuit 108 is operated with voltage 114 that is generated, and said circuit reports water contact 100 via a radio interface 110. The microsystem can be produced, for example, as a silicon MEMS, or also on a plastic basis using hybrid integrated microelectronics 110, or on a plastic basis using integrated organic circuits 110.

Chemical energy reservoir 104 can thus be used for an autonomous microsystem, in which context a direct activation of chemical energy reservoir 104 occurs by way of variable 100 that is to be measured by the autonomous microsystem. Chemical energy reservoir 104 guarantees the provision of a sufficient quantity of energy 114 to enable the autonomous microsystem to wirelessly report 116 a sensor event 100.

It is thus not necessary, for example, for a battery to make available the energy needed to operate an evaluation electronic system, which in turn monitors the environment of the microsystem by way of an electrically operated sensor element, e.g. a temperature sensor, and reports the onset of an event to be monitored, for example a fire. Such a battery could, in contrast to the chemical energy reservoir, already be exhausted at the time of onset of event 100.

The autonomous microsystem shown in FIG. 1 can be used to monitor buildings, including residential buildings, and industrial facilities.

The exemplifying embodiment described with reference to FIG. 1 represents a combination of energy reservoir 104 with the sensor element of an autonomous microsystem. The energy is stored chemically, and released as a result of the onset of event 100 that is to be monitored. With energy 112 that is released, energy harvester 106 can then be operated, powering electronic system 108 of the microsystem in order to report to a central node of a sensor network, for example via a radio interface 110, the occurrence of event 100. The fact that the stored energy is released only by the onset of event 100 guarantees that the stored energy is in fact available at that point in time.

FIG. 2 is a schematic depiction of a monitoring system in accordance with an exemplifying embodiment of the present invention. The monitoring system has a plurality of apparatuses 220 for reporting an event, and an evaluation device 222. Apparatuses 220 can be embodied in accordance with the apparatus described with reference to FIG. 1. Each of apparatuses 220 is linked via an interface 224 to evaluation device 222. Apparatuses 220 are each embodied to generate a signal in response to the occurrence of an event to be reported, and to transfer the signal via interface 224 to evaluation device 222. Evaluation device 222 is embodied to receive a signal that is transferred from one of apparatuses 220 via interface 224. Evaluation device 222 is embodied to evaluate such a received signal. As a consequence of the evaluation, evaluation device 222 can be embodied to trigger an alarm or to output an information item regarding reception of the signal, transfer it to a further device, or store it. Apparatuses 222 can, for example, be disposed at different positions in a housing and can react to the occurrence of water. The events detected by apparatuses 220 can be collected, via interfaces 224, at a central evaluation device 222.

FIG. 3 is a flow chart of a method for reporting an event, in accordance with an exemplifying embodiment of the present invention. The method is based on the use of a chemical energy reservoir and can be implemented, for example, by the apparatus shown in FIG. 1. The method is based in particular on the use of a chemical reaction to report the event triggering the reaction. In a step 330 of the method, a corresponding chemical energy reservoir is kept in readiness. The chemical energy reservoir is kept in readiness in such a way that it is located in an influence region of the event to be reported. This can be ensured by the fact that, for example, the apparatus is located at a suitable position and is suitably oriented. In a step 332, energy made available by the chemical energy reservoir is converted into electrical energy. This can occur for as long as the event lasts, i.e. for example while further water is arriving at the chemical energy reservoir and the chemical energy reservoir is not yet consumed. In a step 334 the electrical energy is used to generate an electrical signal to report the event. The electrical signal can be generated as long as sufficient electrical energy is available. If two events occur at intervals in time, thermal energy can then be generated, converted, and used to generate the electrical signal at each point in time at which one of the events occurs. An electrical signal can thus be generated for each event. Method steps 330, 332, 334 can be cycled through completely in response to each of the events.

The exemplifying embodiments that are described and are shown in the Figures are selected merely by way of example. Different exemplifying embodiments can be combined with one another completely or with regard to individual features. An exemplifying embodiment can also be supplemented with features of a further exemplifying embodiment. In addition, method steps according to the present invention can be repeated and can be executed in a sequence different from the one described.

1-10. (canceled)

11. An apparatus for reporting an event, comprising:
a chemical energy reservoir to release thermal energy upon being influenced by the event;
a converter to convert the thermal energy into electrical energy; and
a circuit to generate, operated by the electrical energy, an electrical signal for reporting the event.

12. The apparatus of claim 11, wherein the energy reservoir, the converter, and the circuit form a microsystem.

13. The apparatus of claim 11, further comprising:
a housing for receiving the energy reservoir, the converter, and the circuit, the housing having, in a region of the energy reservoir, an environmental interface to enable the energy reservoir to be influenced by the event.

14. The apparatus of claim 13, wherein the environmental interface encompasses an opening of the housing.

15. The apparatus of claim 11, wherein the event is an occurrence of moisture, and the energy reservoir is configured to release thermal energy upon contact with moisture.

16. The apparatus of claim 11, wherein the converter encompasses a thermocouple.

17. The apparatus of claim 11, wherein the electrical circuit has a radio interface for wireless transfer of the electrical signal.

18. A monitoring system, comprising:
at least one apparatus for reporting an event, including:
a chemical energy reservoir to release thermal energy upon being influenced by the event;
a converter to convert the thermal energy into electrical energy; and
a circuit to generate, operated by the electrical energy, an electrical signal for reporting the event; and
an evaluation device to receive the electrical signal of the at least one apparatus via an interface and evaluate it.

19. A method for reporting an event, the method comprising:
providing, in readiness, a chemical energy reservoir in an influence region of the event, the chemical energy reservoir being configured to release thermal energy in response to the event;
converting the thermal energy into electrical energy; and
generating, using the electrical energy, an electrical signal to report the event.

20. A chemical energy reservoir, comprising:
an arrangement to release thermal energy upon influence by an event, so as to operate a circuit configured to generate, as operated by the thermal energy converted into electrical energy, an electrical signal for reporting the event.
